(19) United States
(12) Patent Application Publication
(10) Pub. No.: US 2026/0055782 A1
(43) Pub. Date: Feb. 26, 2026

(54) REFRIGERANT COMPRESSOR INCLUDING DIFFUSER WITH QUARTER WAVE TUBES

(71) Applicant: Danfoss A/S, Nordborg (DK)

(72) Inventors: Jin Yan, Tallahassee, FL (US); Karthik Krishna, Tallahassee, FL (US)

(21) Appl. No.: 18/997,533

(22) PCT Filed: Jul. 27, 2023
(86) PCT No.: PCT/US23/28784

§ 371 Date: Jan. 22, 2025

Related U.S. Application Data
(60) Provisional application No. 63/402,498, filed on Aug. 31, 2022.

(51) Int. Cl. F04D 29/66; F25B 31/02

(52) U.S. Cl. CPC F04D 29/665; F25B 31/02; F25B 2500/12

(57) ABSTRACT

This disclosure relates to a refrigerant compressor including a diffuser with one or more quarter wave tubes. The compressor is used in a heating, ventilation, and air conditioning (HVAC) chiller system, for example.

### RELATED APPLICATIONS

This application claims the benefit of International Application No. PCT/US23/28784, filed Jul. 27, 2023 which claims priority to U.S. Provisional Application No. 63/402,498, filed Aug. 31, 2022, the entirety of which is herein incorporated by reference.

### TECHNICAL FIELD

This disclosure relates to a refrigerant compressor including a diffuser with one or more quarter wave tubes. The compressor is used in a heating, ventilation, and air conditioning (HVAC) chiller system, for example.

### BACKGROUND

Refrigerant compressors are used to circulate refrigerant in a chiller via a refrigerant loop. Refrigerant loops are known to include a condenser, an expansion device, and an evaporator. The compressor compresses the fluid, which then travels to a condenser, which in turn cools and condenses the fluid. The refrigerant then goes to an expansion device, which decreases the pressure of the fluid, and to the evaporator, where the fluid is vaporized, completing a refrigeration cycle.

Many refrigerant compressors are centrifugal compressors and have an electric motor that drives at least one impeller to compress refrigerant. Refrigerant flows into the impeller in an axial direction, and is expelled radially from the impeller toward a diffuser. Within the diffuser, the refrigerant broadens and reduces its speed, resulting in an increase in pressure.

### SUMMARY

In some aspects, the techniques described herein relate to a refrigerant compressor, including: a diffuser including a quarter wave tube.

In some aspects, the techniques described herein relate to a refrigerant compressor, wherein the quarter wave tube is a first quarter wave tube configured to attenuate noise of a first frequency, and the diffuser includes a second quarter wave tube configured to attenuate noise of a second frequency different than the first frequency.

In some aspects, the techniques described herein relate to a refrigerant compressor, wherein the diffuser includes a third quarter wave tube configured to attenuate noise of a third frequency different than the first and second frequencies.

In some aspects, the techniques described herein relate to a refrigerant compressor, wherein the first and second quarter wave tubes are provided in a common wall of the diffuser.

In some aspects, the techniques described herein relate to a refrigerant compressor, wherein the quarter wave tube is not a through-opening.

In some aspects, the techniques described herein relate to a refrigerant compressor, wherein refrigerant enters and exits the quarter wave tube via the diffuser.

In some aspects, the techniques described herein relate to a refrigerant compressor, wherein quarter wave tube is configured as a groove in a wall of the diffuser.

In some aspects, the techniques described herein relate to a refrigerant compressor, wherein the groove extends continuously about an entirety of a rotational axis of the refrigerant compressor.

In some aspects, the techniques described herein relate to a refrigerant compressor, wherein the groove is radially aligned and circumferentially spaced-apart from at least one other groove formed in the wall.

In some aspects, the techniques described herein relate to a refrigerant compressor, wherein the quarter wave tube exhibits a length (L) set according to the following formula:

$$L = \frac{2 n - 1}{4} λ ,$$

where n is a whole number and λ is a wavelength of a sound to be attenuated by the quarter wave tube.

In some aspects, the techniques described herein relate to a refrigerant compressor, wherein λ is the blade passing frequency of an impeller of the refrigerant compressor.

In some aspects, the techniques described herein relate to a refrigerant compressor, wherein λ is a harmonic of the blade passing frequency of an impeller of the refrigerant compressor.

In some aspects, the techniques described herein relate to a method, including: attenuating noise within a refrigerant compressor using a quarter wave tube of a diffuser.

In some aspects, the techniques described herein relate to a method, wherein the quarter wave tube is a first quarter wave tube configured to attenuate noise of a first frequency, and the method includes attenuating noise of a second frequency different than the first frequency using diffuser a second quarter wave tube of the diffuser.

In some aspects, the techniques described herein relate to a method, wherein the method includes attenuating noise of a third frequency different than the first and second frequencies using a third quarter wave tube of the diffuser.

### BRIEF DESCRIPTION OF THE DRAWINGS

FIG. 1 schematically illustrates a refrigerant system.

FIG. 2 schematically illustrates a portion of a compressor.

FIG. 3 is a close-up, cross-sectional view of a portion of an example diffuser.

### DETAILED DESCRIPTION

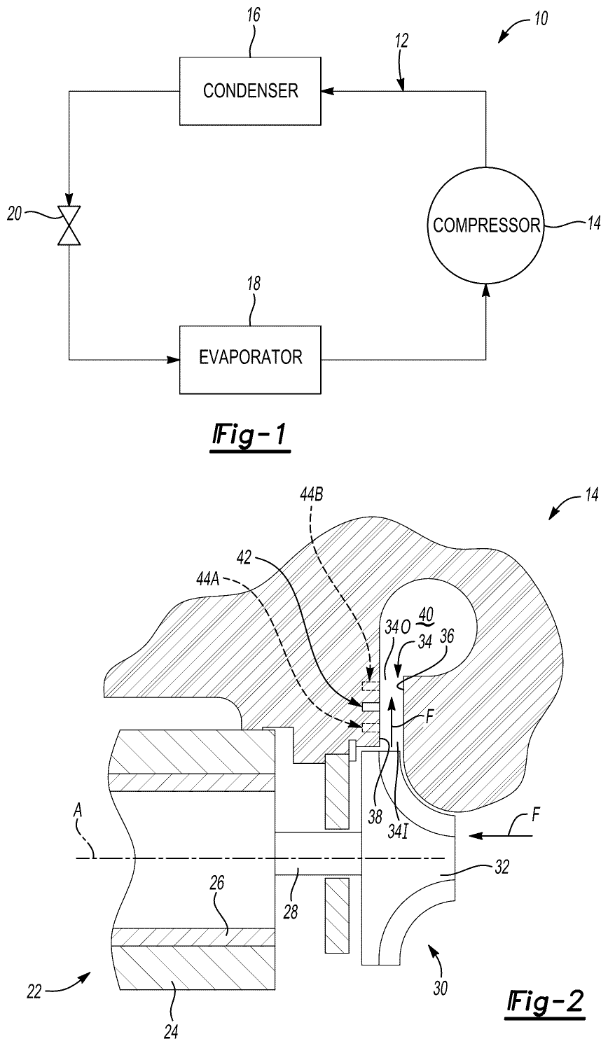

FIG. 1 illustrates a refrigerant system 10. The refrigerant system 10 includes a main refrigerant loop, or circuit, 12 in communication with a refrigerant compressor 14, a condenser 16, an evaporator 18, and an expansion device 20. This refrigerant system 10 may be used in a chiller, for example. In that example, a cooling tower may be in fluid communication with the condenser 16. While a particular example of the refrigerant system 10 is shown, this application extends to other refrigerant system configurations, including configurations that do not include a chiller. For instance, the main refrigerant loop 12 can include an economizer downstream of the condenser 16 and upstream of the expansion device 20.

FIG. 2 illustrates, in cross-section, a portion of the compressor 14. The compressor 14 includes an electric motor 22 having a stator 24 arranged radially outside of a rotor 26. The rotor 26 is connected to a shaft 28, which rotates to drive at least one compression stage 30 of the compressor 14, which in this example includes at least one impeller 32. The compressor 14 may include multiple compression stages. When there are multiple compression stages, each stage may include a diffuser configured as described below.

The shaft 28 and impeller 32 are rotatable by the electric motor 22 about an axis A to compress fluid, which here is refrigerant, F. The terms axial, radial, and circumferential in this disclosure are used relative to the axis A. The shaft 28 may be rotatably supported by a plurality of bearing assemblies, which may be magnetic bearing assemblies.

During operation of the compressor 14, refrigerant F flows axially toward the impeller 32 and is expelled radially outwardly to a diffuser 34 downstream of the impeller 32. The diffuser 34 is a channel having an inlet 341 and an outlet 340 arranged axially between a first wall 36 and a second wall 38, and arranged radially between the outlet of the impeller 32 and an inlet to a volute 40. The volute 40 may be in fluid communication with the condenser 16 or another compression stage of the compressor 14. Within the diffuser 34, refrigerant F expelled by the impeller 32 broadens and reduces in speed, resulting in an increase in pressure of the refrigerant F.

In some operational conditions of the compressor 14, the flow characteristics of the refrigerant F may create noise. Specifically, as refrigerant F flows through the diffuser 34, flow perturbation in the form of pressure waves are also introduced into the diffuser 34. The pressure waves will oscillate at a range of frequencies and can create noise. In this disclosure, the diffuser 34 includes features configured to attenuate that noise.

As shown in FIG. 2, the diffuser 34 includes a quarter wave tube 42 in the second wall 38. The quarter wave tube 42 is not a through-opening. Rather, refrigerant F enters and exits the quarter wave tube 42 via the diffuser 34. The quarter wave tube 42 is formed as a groove or recess in a wall of the diffuser 34, which here is the second wall 38. In a particular example, the quarter wave tube 42 is configured as a groove and extends circumferentially and continuously about the entirety of the axis A. In another embodiment, the second wall 38 includes a plurality of quarter wave tubes 42 that are radially aligned and circumferentially spaced-apart from one another. In that embodiment, the second wall 38 includes a plurality of recesses, formed by drilling for example.

While the quarter wave tube 42 is formed in the second wall 38, it could be formed in the first wall 36. Further, it should be understood that while only one quarter wave tube 42 is shown in FIG. 2, the diffuser 34 could include multiple quarter wave tubes. Two additional, optional quarter wave tubes 44A, 44B are shown in dashed lines in FIG. 2. The quarter wave tube 42 may be configured to attenuate noise having a certain frequency. Additional quarter wave tubes, such as quarter wave tubes 44A, 44B, if present, may be configured to attenuate noises of different frequencies. If multiple quarter wave tubes are present within the diffuser 34, they may each be provided in the same one of the diffuser walls, such as the second wall 38, or in different walls.

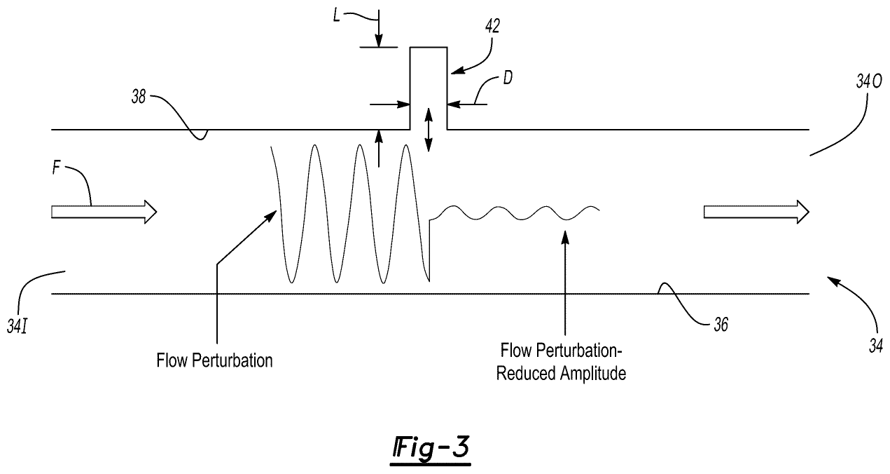

With reference to FIG. 3, the quarter wave tube 42 exhibits a length L and a diameter D. In an example, length L is set according to the following formula:

$$L = \frac{2 n - 1}{4} λ \qquad ( Equation 1 )$$

In Equation 1, n is a whole number such as 0, 1, 2, 3, etc., and λ is the wavelength of the sound to be attenuated by the quarter wave tube 42. In this way, L is equal to ¼λ or a multiple of ¼ λ. The diameter D may be set using a known formula to provide a desired volume for the quarter wave tube 42.

In an example, λ is set to the blade passing frequency of the impeller 32 or harmonics thereof. When multiple quarter wave tubes are present, λ may be set to correspond to the blade passing frequency for quarter wave tube 42, and additional quarter wave tubes may be set to correspond to different respective harmonics of the blade passing frequency such that each of the quarter wave tubes is configured to attenuate noise of a different frequency.

As generally shown in FIG. 3, as refrigerant F flows through the diffuser 34, some of the refrigerant F enters the quarter wave tube 42, which creates pressure wave reflections that interact with the refrigerant F within the diffuser 34 to dampen the pressure waves within the diffuser 34. The quarter wave tube 42 lessens the amplitude of those waves to about ¼ of the amplitude upstream of the quarter wave tube 42, which attenuates the noise associated with the pressure waves of the refrigerant F. In turn, the noise output of the compressor 14 is decreased.

It should be understood that terms such as “axial” and “radial” are used above with reference to the normal operational attitude of a compressor. Further, these terms have been used herein for purposes of explanation, and should not be considered otherwise limiting. Terms such “generally,” “about,” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A refrigerant compressor, comprising:
a diffuser including a quarter wave tube.

2. The refrigerant compressor as recited in claim 1, wherein the quarter wave tube is a first quarter wave tube configured to attenuate noise of a first frequency, and the diffuser includes a second quarter wave tube configured to attenuate noise of a second frequency different than the first frequency.

3. The refrigerant compressor as recited in claim 2, wherein the diffuser includes a third quarter wave tube configured to attenuate noise of a third frequency different than the first and second frequencies.

4. The refrigerant compressor as recited in claim 2, wherein the first and second quarter wave tubes are provided in a common wall of the diffuser.

5. The refrigerant compressor as recited in claim 1, wherein the quarter wave tube is not a through-opening.

6. The refrigerant compressor as recited in claim 5, wherein refrigerant enters and exits the quarter wave tube via the diffuser.

7. The refrigerant compressor as recited in claim 1, wherein quarter wave tube is configured as a groove in a wall of the diffuser.

8. The refrigerant compressor as recited in claim 7, wherein the groove extends continuously about an entirety of a rotational axis of the refrigerant compressor.

9. The refrigerant compressor as recited in claim 7, wherein the groove is radially aligned and circumferentially spaced-apart from at least one other groove formed in the wall.

10. The refrigerant compressor as recited in claim 1, wherein the quarter wave tube exhibits a length (L) set according to the following formula:
$$L = \frac{2 n - 1}{4} λ ,$$
where n is a whole number and λ is a wavelength of a sound to be attenuated by the quarter wave tube.

11. The refrigerant compressor as recited in claim 10, wherein λ is the blade passing frequency of an impeller of the refrigerant compressor.

12. The refrigerant compressor as recited in claim 10, wherein λ is a harmonic of the blade passing frequency of an impeller of the refrigerant compressor.

13. A method, comprising:
attenuating noise within a refrigerant compressor using a quarter wave tube of a diffuser.

14. The method as recited in claim 13, wherein the quarter wave tube is a first quarter wave tube configured to attenuate noise of a first frequency, and the method includes attenuating noise of a second frequency different than the first frequency using diffuser a second quarter wave tube of the diffuser.

15. The method as recited in claim 14, wherein the method includes attenuating noise of a third frequency different than the first and second frequencies using a third quarter wave tube of the diffuser.
